(19) United States
(12) Patent Application Publication
(10) Pub. No.: US 2026/0064653 A1
(43) Pub. Date: Mar. 5, 2026

(54) METHOD, APPARATUS, DEVICE AND MEDIA FOR MANAGING DATA IN AN APPLICATION

(71) Applicant: Beijing Zitiao Network Technology Co., Ltd., Beijing (CN)

(72) Inventors: Zeqing Xie, Beijing (CN); Yifan Yang, Beijing (CN)

(21) Appl. No.: 18/928,633

(22) Filed: Oct. 28, 2024

Related U.S. Application Data
(63) Continuation of application No. PCT/CN2024/114939, filed on Aug. 27, 2024.

(51) Int. Cl. G06F 16/22

(52) U.S. Cl. CPC G06F 16/2291

(57) ABSTRACT

A method, apparatus, device, and medium for managing data in an application are provided. In a method, raw data in an application is received, the raw data including a definition of at least one data item. Mixed data associated with at least one data item is obtained, the mixed data including a first data portion in a first format and a second data portion in a second format. Here, the first format includes any one of a string format and an object format, the second format includes the other one of the string format and the object format, and for a data item in the at least one data item, the mixed data includes a data item represented in the first format or a data item represented in the second format. Storage resource overheads for loading relevant data of an application may be reduced.

### CROSS-REFERENCE

This application claims priority to Patent Application No. PCT/CN2024/114939, filed with the China National Intellectual Property Administration on Aug. 27, 2024, and entitled “METHOD, APPARATUS, DEVICE AND MEDIA FOR MANAGING DATA IN AN APPLICATION”, the disclosures of which are incorporated herein by reference in their entities.

### FIELD

Example implementations of the present disclosure relate generally to computer technology, and more particularly, relate to a method, apparatus, device, and computer-readable storage medium for managing data in an application.

### BACKGROUND

An application may be run on an electronic device of a plurality of function types, and the application may include various predefined data, and the data may be loaded into a memory (for example, an internal memory) of the electronic device, so as to execute functions of an application program. An application may include a large amount of data, and the data occupies a large amount of storage space of a memory. In this case, it is expected that data in the application may be managed in a more effective manner, thereby reducing the application's storage space requirement.

### SUMMARY

In a first aspect of the disclosure, a method for managing data in an application is provided. In this method, raw data in an application is received, the raw data comprising a definition of at least one data item. Mixed data associated with at least one data item is obtained, the mixed data comprising a first data portion in a first format and a second data portion in a second format. Here, the first format comprises any one of a string format and an object format, the second format comprises the other one of the string format and the object format, and for the data item of the at least one data item, the mixed data comprises a data item represented in the first format or a data item represented in the second format.

In a second aspect of the present disclosure, an apparatus for managing data in an application is provided. The apparatus comprises: a receiving module configured to receive raw data in the application, the raw data comprising a definition of at least one data item; and an obtaining module configured to obtain mixed data associated with the at least one data item, the mixed data comprising a first data portion in a first format and a second data portion in a second format, where the first format comprises any one of a string format and an object format, the second format comprises the other one of the string format and the object format, and for a data item in the at least one data item, the mixed data comprises a data item represented in the first format or a data item represented in the second format.

In a third aspect of the present disclosure, an electronic device is provided. The electronic device comprises: at least one processing unit; and at least one memory coupled to the at least one processing unit and storing instructions for execution by the at least one processing unit that, when executed by the at least one processing unit, cause the electronic device to perform a method according to the first aspect of the present disclosure.

In a fourth aspect of the present disclosure, there is provided a computer readable storage medium having stored thereon a computer program which, when executed by a processor, causes the processor to implement the method according to the first aspect of the present disclosure.

In a fifth aspect of the present disclosure, there is provided a computer program product, comprising a computer program, where the computer program, when executed by a processor, implements the method according to the first aspect of the present disclosure.

It should be appreciated that what is described in this Summary is not intended to limit the key features or essential features of the implementations of the present disclosure, nor is it intended to limit the scope of the present disclosure. Other features of the present disclosure will become readily appreciated from the following description.

### BRIEF DESCRIPTION OF THE DRAWINGS

Hereinafter, the above and other features, advantages, and aspects of various implementations of the present disclosure will become more apparent with reference to the following detailed description taken in conjunction with the accompanying drawings. In the drawings, identical or similar reference numbers denote identical or similar elements, where:

FIG. 1 illustrates a block diagram of relationships between various data in an application;

FIG. 2 illustrates a block diagram for managing data in an application according to some implementations of the present disclosure;

FIG. 3 illustrates a block diagram of data items in raw data according to some implementations of the present disclosure;

FIGS. 4A-4E illustrate block diagrams of a data conversion process between string format and object format according to some implementations of the present disclosure;

FIG. 5 illustrates a block diagram of data in a heap of an application according to some implementations of the present disclosure;

FIG. 6 illustrates a flowchart of a method for managing data in an application according to some implementations of the present disclosure;

FIG. 7 illustrates a block diagram of an apparatus for managing data in an application according to some implementations of the present disclosure; and

FIG. 8 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the drawings, it should be understood that the present disclosure may be implemented in various forms and should not be construed as limited to the implementations set forth herein; rather, these implementations are provided for a thorough and complete understanding of the present disclosure. It should be understood that the drawings and implementations of the present disclosure are only for exemplary purposes and are not intended to limit the scope of protection of the present disclosure.

In the description of implementations of the present disclosure, the term “comprising” and its similar words should be understood as open-ended including, that is, “comprising but not limited to”. The term “based on” should be read as “based at least in part on”. The term “one implementation” or “the implementation” should be read as “at least one implementation”. The term “some implementations” should be understood as “at least some implementations”. Other explicit and implicit definitions may also be included below. As used herein, the term “model” may denote an association relationship between respective data. The association relationship may be obtained, for example, based on a variety of technical solutions that are currently known and/or will be developed in the future.

It is to be understood that the data involved in the technical solution (including but not limited to the data itself, the acquisition or use of the data) should comply with the requirements of the corresponding legal regulations and related provisions.

It should be understood that, before the technical solutions disclosed in the embodiments of the present disclosure are used, the user should be informed of the type of the personal information, the usage range, the usage scenario, and the like related to the present disclosure and the authorization of the user should be obtained in an appropriate manner according to relevant legal regulations.

For example, in response to receiving an active request from a user, prompt information is sent to the user to explicitly prompt the user that an operation requested by the user will require acquisition and use of personal information of the user. Thus, the user may autonomously select, according to the prompt information, whether to provide personal information to software or hardware such as an electronic device, an application program, a server, or a storage medium that executes the operations of the technical solutions of the present disclosure.

As an optional but non-limiting implementation, a manner of sending prompt information to a user in response to receiving an active request from the user may be, for example, a manner of popping up a window, and the prompt information may be presented in a text manner in the pop-up window. In addition, the pop-up window may also carry a selection control for the user to select “agree” or “do not agree” to provide personal information to the electronic device.

It may be understood that, the above processes of notifying and obtaining the user authorization are only illustrative, and do not limit the implementation of the present disclosure, and other methods meeting relevant legal regulations may also be applied to the implementation of the present disclosure.

As used herein, the term “in response to” refers to a state in which a corresponding event occurs or a condition is satisfied. It will be appreciated that the execution timing for a subsequent action that is executed in response to the event or condition is not necessarily strongly correlated with the time when the event or condition occurs or is satisfied. For example, in some cases, subsequent actions may be performed immediately upon occurrence of an event or upon satisfaction of a condition; in some other cases, subsequent actions may be performed only after a period of time has elapsed since an event occurs or a condition is satisfied.

### Example Environment

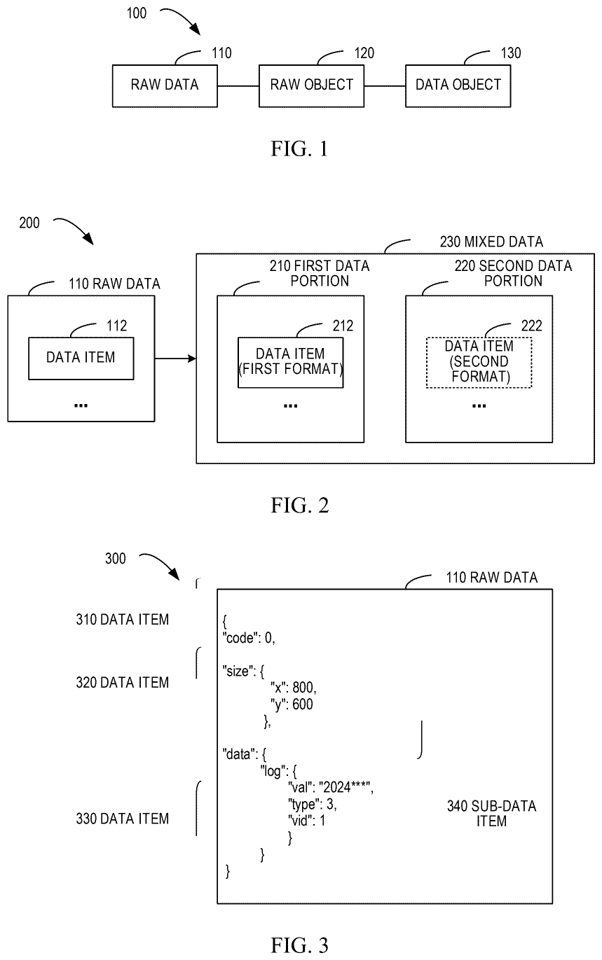

The application may include various data defined in advance, and the data may be loaded into a memory (for example, an internal memory) of the electronic device, so as to complete functions of the application program. An application may include a large amount of data that will occupy a significant amount of storage space of a memory. An application environment in accordance with some implementations of the present disclosure is described with reference to FIG. 1, which illustrates a block diagram 100 of relationships between various data in an application.

For ease of description, according to some implementations to the present disclosure, the specific process for managing data in an application will be described by using only an application executed in an Android environment as an example. As shown in FIG. 1, the application may include raw data 110, which may be defined in a variety of formats. For example, JSON (JavaScript Object Notation) may be used to define data. JSON is a lightweight data interchange format, which is easy for people to read and write, and is also easy for machine to parse and generate. JSON is a subset of JavaScript and includes keys and values.

In the Android environment, data items defined in JSON format may be loaded into the memory (e. g., heap in memory) of the electronic device and the corresponding data items may be accessed. Specifically, the raw data 110 may be converted to an raw object 120 (e. g., in a JSONObject format), and then, the raw object 120 may be converted to a data object 130, that is, an object instance of a corresponding type is generated by an instantiation operation. At this point, the heap may include data items in multiple formats, such as raw data 110 in string format, raw object 120 in string format, and data object 130 in object format. This results in significant overhead in storage space. At this point, it is desirable to manage the data in the application in a more efficient manner, thereby reducing the need for storage space.

### SUMMARY OF MANAGEMENT APPLICATION

In order to at least partially remove the drawbacks in the prior art, according to one example implementation of the present disclosure, a method is proposed for managing data in an application. An overview of one example implementation according to the present disclosure is described with reference to FIG. 2, which illustrates a block diagram 200 for managing data in an application according to some implementations of the present disclosure. As shown in FIG. 2, raw data 110 in an application may be received, and the raw data 110 may include a definition of at least one data item (e. g., data item 112). In turn, mixed data 230 associated with at least one data item may be obtained.

Herein, the mixed data 230 may include a first data portion 210 in a first format and a second data portion 220 in a second format. Specifically, the first format may include any one of a string format and an object format, and the second format may include the other one of the string format and the object format. For data items in the at least one data item, the mixed data 230 includes a data item represented in the first format or a data item represented in the second format. In other words, only data items represented in one of the two formats are included.

For a data item 112, the data item 112 is a string expressed in JSON format, the specific content of the string may be parsed, and a data item 212 or 222 is generated. It should be appreciated that for a certain data item, the mixed data includes only the corresponding data item represented in the first format, or only the corresponding data item represented in the second format. As shown in FIG. 2, assuming that the first data portion 210 of the mixed data 230 includes a data item 212 that is represented in a first format, the data item 222 represented in a second format is not included in the second data portion 220 (as indicated by the dashed line). Alternatively, and/or additionally, assuming that the second data portion 220 of the mixed data 230 includes a data item 222 that is represented in the second format, the data item 212 that is represented in the first format is not included in the first data portion 210.

With some implementations of the present disclosure, the mixed data 230 includes only one copy of one format of the data item, in this manner, the storage space requirement of the mixed data 230 may be reduced, thereby reducing the storage resource overhead of the application.

### DETAILED PROCESS FOR MANAGING APPLICATION

An overview of some implementations according to the present disclosure has been described above, in the following, more details of some implementations according to the present disclosure are described with reference to the accompanying drawings. FIG. 3 illustrates a block diagram 300 of data items in raw data in accordance with some implementations of the present disclosure. The raw data may include at least one data item. FIG. 3 merely shows three data items by way of example. Alternatively, and/or additionally, the raw data 110 may include more or less data items.

As shown in FIG. 3, the raw data 110 is expressed in a JSON format and may include data items 310, 320, and 330. The data item 310 may represent a simple data item, and at this time, a key of the data item is “code” and a value is “0” (for example, expressed in integer “int”). That is, the data item 310 defines the variable “code” of the integer, and the specific value of the variable is “0”. Alternatively, and/or additionally, the raw data 110 may include other simple data items of other types (e. g., floating point, string, array, etc.).

The data item 320 may represent an object type, at which point the key for the data item is “size” and the value is: “x”: 800, “y”: 600. As another example, a data item 330 may represent a complex data item with a key of “data” and a value of another object “log” (i.e., sub-data item 340). The key of the another object is “log” and the value is Object: “val”: “2024 **” “type”: 3, “vid”: 1.

It should be appreciated that although the data item 330 includes only one sub-data item, in other definitions, the data item may include one or more levels of nested sub-data items. For example, another nested sub-object of a lower level may be included in the sub-data item 340, and this another nested sub-object may include a nested sub-object of a lower level, etc. FIG. 3 merely illustrates an example of a data item, alternatively and/or additionally, other data items that may have different keys and values.

According to some implementations of the present disclosure, the first format may be a string format and the second format may be an object format. Alternatively, and/or additionally, the first format and the second format may be exchanged, and in this case, the second format may be a string format, and the first format may be an object format. For convenience of description, the process of determining the mixed data 230 is hereinafter described by taking the character string as the first format and the object as the second format.

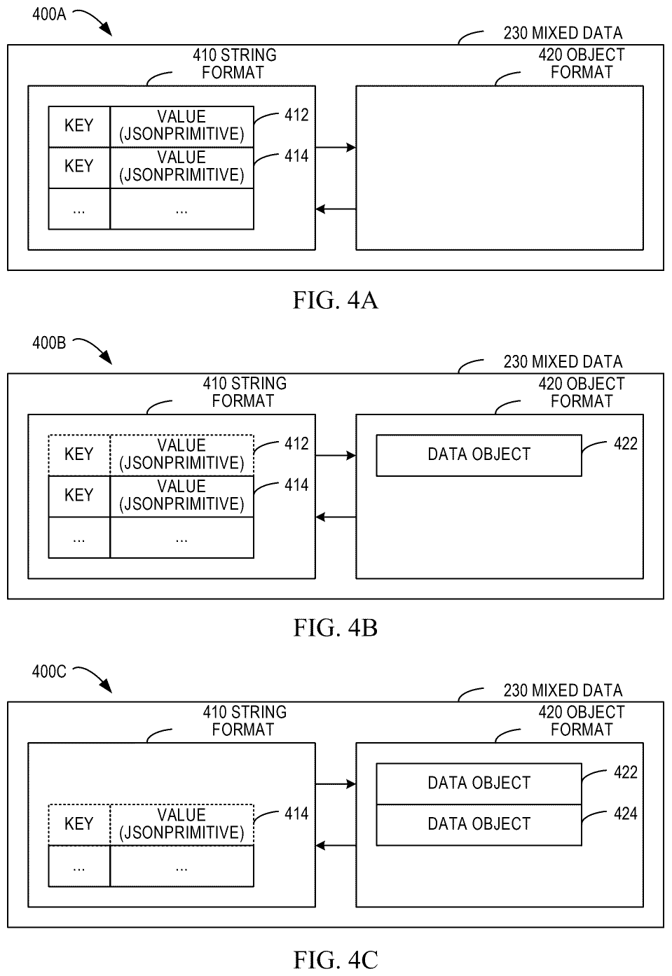

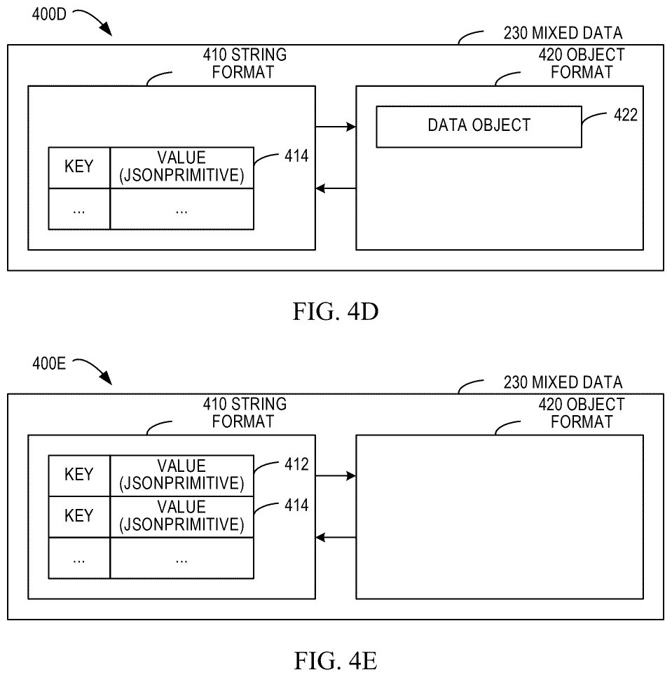

According to some implementations of the present disclosure, a first data portion is obtained based on a definition of at least one data item, the first data portion may include at least one data entry corresponding to the at least one data item, the data entry of the at least one data entry being represented in a string format and including a key and a value; a second data portion is obtained, where the second data portion is empty. Further details are described with reference to FIGS. 4A-4E, and the FIGS. 4A-4E illustrate block diagrams 400A-400E of a data conversion process between string format and object format, in accordance with some implementations of the present disclosure.

As shown in FIG. 4A, a first data portion represented in a string format 410 and a second data portion represented in an object format 420 may be generated. Specifically, the raw data 110 may be read and each data item is extracted according to the definition of JSON. The data item in the raw data may be converted into a JSONObject format. For example, it may be represented by a linked hash map (LinkedHashMap) to determine a corresponding data entry. For example, the data item 310 may be converted to data entry 412, where the key may represent a “code” and the value may represent a “0”. Here, the value may be expressed in a JSONPrimitive format. Here, JSONPrimitive generally represents a raw data type in a JSON data format. As another example, the data item 320 may be converted to the data entry 414, at which point the key may represent “size” and the value may represent: “x”: 800, “y”: 600.

In an initial phase, a first data portion represented in a string format may be determined, and a second data portion may be empty. With some implementations of the present disclosure, the mixed data 230 only includes a string format and does not double the storage space overhead.

According to some implementations of the present disclosure, in response to receiving a first access request from a service logic of an application for a data item, a data object corresponding to the data item is obtained based on a data entry corresponding to the data item among at least one data entry, the data object being represented in an object format; a data object is stored to a second data portion; and a data entry is removed from the first data portion.

With the use of an application, a business logic in the application may access a defined data item. In this case, the data item needs to be converted from the character string format into the object format, so as to perform a subsequent calculation operation. In particular, assuming that the business logic accesses a data entry 412, a corresponding data object (e. g., data object 422) may be obtained. At this point, the data object 422 may be added to the second data portion represented in object format 420, and the data entry 412 (shown as a dashed line) is removed from the first data portion represented in string format. At this point, the mixed data 230 includes data entries 414, etc., represented in string format 410, and data objects represented in object format 420.

With some implementations of the present disclosure, since the data entry 412 has been removed from the mixed data 230, the storage space occupied by the data entry 412 will be released, and the overall storage space of the mixed data 230 will remain substantially unchanged. The storage space occupied by the mixed data 230 may be greatly reduced as compared with prior art solutions that require maintaining both copies of the string format and object format at the same time.

According to some implementations of the present disclosure, in the process of obtaining the first data portion, the name and the data value of the data item are obtained from the definition of the data item; and a key of the data entry is set based on the name and a value of the data entry is set based on the data value. Specifically, the name and data value of data item may be extracted according to the definition of JSON. For example, a comma “,” may be used to separate two data items, and a colon “:” may be used to separate a name and a value. In this case, the portion before the colon may be used as a name, and the portion after the colon may be used as a data value. Similar operations may be performed for each data item, thereby obtaining a data entry corresponding to each data item. With some implementations of the present disclosure, names and data values may be extracted in a simple and efficient manner, thereby generating corresponding data entries.

According to some implementations of the present disclosure, in a process of obtaining a data object, a name of the data object may be determined based on a key of the data entry; and an instance of the data object may be determined based on the value of the data entry. Continuing with the above example, the key and value of data entry 412 are “code” and “0”, respectively, at which point, an instance of a respective data object may be generated through an instantiation operation. Specifically, the corresponding storage space may be divided in the heap of the application to store the instance, and then the business logic of the application may access the instance to perform the subsequent computing operation.

According to some implementations of the present disclosure, the object format may be stored in the form of a Hash Map, and the instance has a type specified by the definition. Assume that a “0” in data entry 412 is represented in integer, an instance represented in integer may be generated at this time, and the name of the instance is “code”. In this manner, corresponding instances may be generated in a desired format to achieve desired functionality of the application.

Corresponding object data may be created for other data items in a similar manner, see FIG. 4C for more details. FIG. 4C illustrates a block diagram 400C of a data conversion process between a string format and an object format, in accordance with some implementations of the present disclosure. As illustrated in FIG. 4C, in response to receiving an access request for data entry 414, data object 424 may be established and data entry 414 is deleted (as indicated by the dashed line). At this point, the name of the data object 424 is “size” and the example is of Object type, and it includes: “x”: 800, “y”: 600. At this point, the variables x and y may be of the type defined in the raw data, e. g., integer type.

Alternatively, and/or additionally, all data items may be loaded into the heap by default during the application launch phase to form data entries in a string format, and then, various data entries are then converted to corresponding data objects. In this manner, data objects may be pre-obtained, thereby increasing access speeds to the data objects.

The process of converting from the string format 410 to the object format 420 has been described, alternatively and/or additionally, a reverse conversion may be performed, i.e., converting from object format 420 to string format 410. At this point, the first format and the second format may be exchanged, and the first data portion and the second data portion may also be exchanged accordingly.

According to some implementations of the present disclosure, the first format is an object format and the second format is a string format. Further, in response to receiving a second access request from a business logic of an application for a data item, a data entry corresponding to the data item is obtained based on a data object corresponding to the data item in the first data portion, the data entry being represented in a string format; the data entry is written to the second portion; and the data object is removed from the first portion.

Specifically, if the business logic of the application needs to access the raw string format, a reverse conversion process may be performed. At this point, the data object 424 in FIG. 4C will be reversely converted to a data entry 414. During the conversion, the instantiated data object may be converted to a string format, e. g., the name “size” of the data object is converted to the string “size” and the variable x (with a value of 800) and the variable y (with a value of 600) in the data object to the string: “x”: 800, “y”: 600. At this point, a corresponding data entry 414 may be generated, i.e., the key is “size”, and the value is: “x”: 800, “y”: 600. Further, a corresponding data entry may be written to the data portion in string format and a corresponding data entry may be deleted from the data portion in object format.

Further details are described with respect to FIG. 4D. FIG. 4D illustrates a block diagram 400D of a data conversion process between a string format and an object format in accordance with some implementations of the present disclosure. At this point, the data portion in object format 420 includes only data object 422, and the data portion in string format 410 includes a data entry 414, etc. Similarly, the data object 422 may be converted to corresponding data entry 412. FIG. 4E illustrates a block diagram 400E of a data conversion process between string format and object format, in accordance with some implementations of the present disclosure. At this point, the data portion of object format 420 is empty, and the data portion of string format 410 includes data entries 412, 414, etc.

It should be appreciated that although only the process of generating a simple type of data object is illustrated above, alternatively and/or additionally, complex data types including nested sub-data item(s) may be processed in a similar manner. According to some implementations of the present disclosure, during obtaining of a data entry, a value of the data entry may be determined based on a sub-data item, the value including a sub-data entry associated with the sub-data item. With some implementations of the present disclosure, data items involving complex structures (e. g., nested structures) are allowed to be defined in an application to support the application to perform complex tasks.

Specifically, for the data item 330 shown in FIG. 3, names and data values of respective sub-data items included in the data item may be obtained in an iterative way, respectively, and corresponding data items may be generated. At this point, the key of the data entry may be represented as “data”, and the value may be represented as another data entry. The key of the another data entry may be represented as “log”, and the value may be represented as: “val”: “2024 ** “, “type”: 3, “vid”: 1. In other words, the value at this time is a data entry corresponding to the object type.

It should be appreciated that the above paragraphs describe the case where one nested sub-data item is included by taking data item 330 as an example. A data item may include a plurality of nested sub-data items at the same level, where each sub-data item may be processed in a similar manner, thereby generating a data entry having a plurality of sub-data entries.

Alternatively, and/or additionally, a data item may include multiple nested sub-data items at different levels. At this point, each sub-data item may be processed in a similar manner, thereby generating a data entry having a plurality of sub-data entries at more levels. With some implementations of the present disclosure, defined data items may be loaded into the heap in a simple and efficient manner, thereby supporting subsequent processing of the application.

Further, in obtaining the instance of the data object, sub-instances of the sub-data object may be obtained based on the sub-data entries, and the sub-instance may be added to the instance. Continuing with data item 330 as an example, a data object named “data” may be generated, and a corresponding sub-instance may be created based on the sub-data entry “log”. The name of the sub-instance may be “log”, the specific content of the instance is an object type, and the object includes three variables, i.e., a variable “val” of a string type (with a value of 2024 ***) and an integer variable “type” (with a value of 3) and “vid” (with a value of 1). With some implementations of the present disclosure, an instance of a defined data object may be generated in a heap in a simple and efficient manner, thereby supporting subsequent processing of the application.

It should be appreciated that for data objects with complex structure, the data objects with complex structure may be converted to a string format in a similar process as described above. For example, a sub-data object having a maximum depth N may be found in a depth-first manner and converted into a corresponding sub-data entry (depth N). Further, one or more sub-data objects having a previous depth to the maximum depth may be processed, so as to generate corresponding sub-data objects (the depth is N−1). Sub-data objects with a smaller depth may be progressively processed in an iterative fashion until a data object at the root position (root, depth 1) is determined.

In particular, an instance “log” of the data object may be converted into a corresponding sub-data entry (with a depth 2, and the key may be represented as “log”, and the value may be represented as “val”: “2024 ** “, “type”: 3, “vid”: 1). The data entry at the root position may be further determined, the key may be represented as “data”, and the value is the sub-data entry at the determined depth of 2. With some implementations of the present disclosure, conversions may be performed between the string format and the object format in a simple and efficient manner to ensure that the mixed data does not take up excessive storage space during the running of the application.

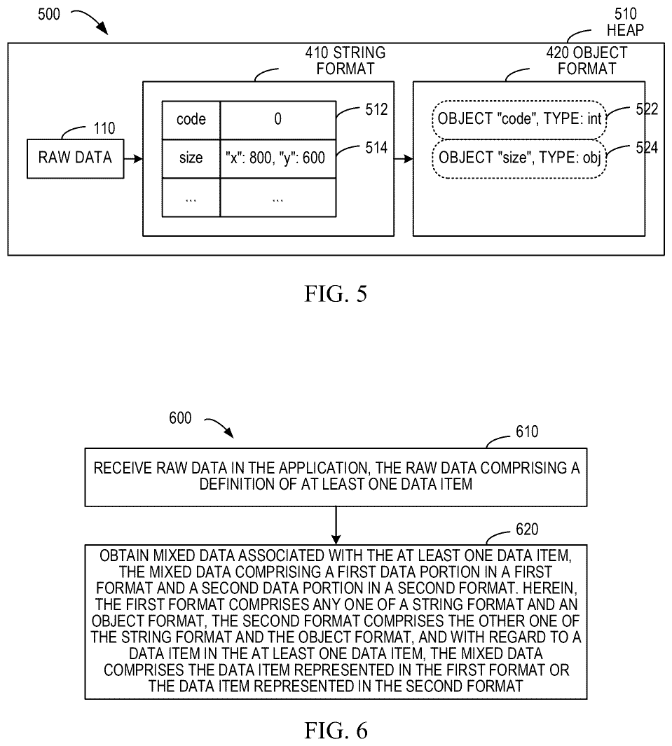

According to some implementations of the present disclosure, a mixed object is stored in a heap of memory of a device for executing an application. More details are described with reference to FIG. 5. FIG. 5 illustrates a block diagram 500 of data in a heap of an application in accordance with some implementations of the present disclosure. During the running of an application, raw data 110 may be loaded into a heap 510 of a memory of an electronic device executing the application, and then the mixed data 530 (including data in both a string format 410 and an object format 420) may be generated based on the raw data 110.

For the raw data 110 as shown in FIG. 3, the data item 310 is converted to a data entry 512 in a string format, the data item is converted to a data entry 514 in a string format, and so on. In turn, as the business logic of an application accesses various data items 310, 320, etc., data entries 512, 514, etc. may be converted to data objects 522, 524, etc. of object format 420. At this point, for a single data item, only a single data item in string format or in object format is included in heap 510, i.e., the heap only includes a data entry in string format or a data object in object format.

Assuming that the size of the storage space occupied by the raw data 110 is A, the size of the storage space occupied by the mixed data is also about A, and at this time, the size of the storage space occupied by the heap 510 is about 2A. However, in prior art solutions, both data item in string format 410 and data item in object format 420 are stored in heap 510, and in this case, heap 510 occupies about 3A of storage space. By means of some implementations of the present disclosure, the overhead of a storage space occupied by an application may be greatly reduced, i.e., reduced from 3A to 2A.

It should be understood that, although a technical solution for reducing storage space overheads based on a cache has been developed at present, the technical solution may only be used for reducing a storage space of a simple constant data item (for example, an integer type, a character string type, a floating-point type, and the like), which is not suitable for a data item of a complex data type (for example, a complex data type including nested data). In this case, the more data items of the complex data type defined in the raw data 110 are, the greater the amount of storage space is saved. In one case, assuming that all of the data items in the raw data 110 are of a complex type, the overhead of the storage space may be reduced from 3A to 2A. In other cases, assuming that some of the data items in the raw data 110 are of a complex type, the overhead of the storage space may be reduced from to some value between 2A and 3A.

It should be understood that although a specific process of managing data in an application is described above with an application executed in an Android environment as an example. Alternatively, and/or additionally, applications may be executed in other application environments, for example, applications may be executed in IOS and/or other environments. In this case, other types may be involved in the execution process. Data entries in a corresponding string format and data objects in an object format may be created based on the process described above according to the type supported in other environments, thereby achieving the purpose of reducing memory resource overhead.

With some implementations of the present disclosure, for a data item in at least one data item, the mixed data includes a data item represented in a first format or a data item represented in a second format. In this way, storage resource overhead for loading relevant data of an application may be reduced to some extent, thereby improving performance of the application.

### Example Processes

FIG. 6 illustrates a flowchart of a method 600 for managing data in an application according to some implementations of the present disclosure. At block 610, raw data in the application is received, the raw data comprising a definition of at least one data item. At block 620, mixed data associated with at least one data item is obtained, the mixed data comprising a first data portion in a first format and a second data portion in a second format. In this case, the first format comprises any one of a string format and an object format, the second format comprises the other one of the string format and the object format, and with regard to a data item in the at least one data item, the mixed data comprises the data item represented in the first format or the data item represented in the second format.

According to some implementations of the present disclosure, the first format is the string format and the second format is the object format, and obtaining the mixed data comprises: obtaining the first data portion based on the definition of the at least one data item, the first data portion comprising at least one data entry corresponding to the at least one data item, a data entry in the at least one data entry being represented in the string format and comprising a key and a value; and obtaining the second data portion, the second data portion being empty.

According to some implementations of the present disclosure, the method 600 further comprises: in response to receiving a first access request from a business logic of the application for the data item, obtaining a data object corresponding to the data item based on a data entry corresponding to the data item in the at least one data entry, the data object being represented in the object format; storing the data object into the second data portion; and removing the data entry from the first data portion.

According to some implementations of the present disclosure, obtaining the first data portion comprises: obtaining a name and a data value of the data item from the definition of the data item; and setting the key of the data entry based on the name, and setting the value of the data entry based on the data value.

According to some implementations of the present disclosure, obtaining the data object comprises: determining a name of the data object based on the key of the data entry; and determining an instance of the data object based on the value of the data entry.

According to some implementations of the present disclosure, the object format is stored in a form of hash map and the instance has a type specified by the definition.

According to some implementations of the present disclosure, the data item is of a complex data type, a value of the complex data type comprises a nested sub-data item, where obtaining the data entry comprises determining the value of the data entry based on the sub-data item, the value comprising a sub-data entry associated with the sub-data item.

According to some implementations of the present disclosure, obtaining the instance of the data object comprises: obtaining a sub-instance of the sub-data object based on the sub-data entry; and adding the sub-instance to the instance.

According to some implementations of the present disclosure, a first format is an object format, and a second format is a string format. The method 600 further comprises: in response to receiving a second access request of a business logic of the application for the data item, obtaining a data entry corresponding to the data item based on a data object corresponding to the data item in the first data portion, the data entry being represented in the string format; writing the data entry to the second portion; and removing the data object from the first portion.

According to some implementations of the present disclosure, the mixed data is stored in a heap of a memory of a device for executing the application.

### Example Apparatus and Device

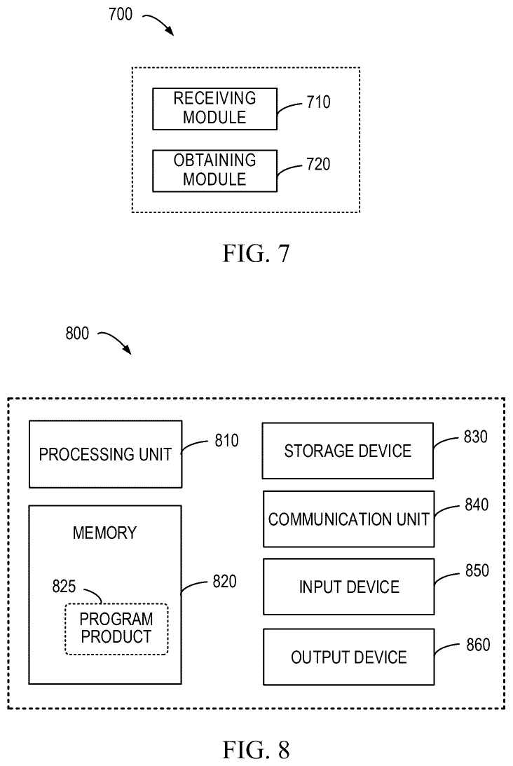

FIG. 7 illustrates a block diagram of an apparatus 700 for managing data in an application in accordance with some implementations of the present disclosure. The apparatus 700 comprises: a receiving module 710 configured to receive raw data in the application, the raw data comprising a definition of at least one data item; and an obtaining module 720 configured to obtain mixed data associated with the at least one data item, the mixed data comprising a first data portion in a first format and a second data portion in a second format, where the first format comprises any one of a string format and an object format, the second format comprises the other one of the string format and the object format, and for a data item in the at least one data item, the mixed data comprises a data item represented in the first format or a data item represented in the second format.

According to some implementations of the present disclosure, the first format is the string format and the second format is the object format, and the obtaining module 720 is further configured to obtain the first data portion based on the definition of the at least one data item, the first data portion comprising at least one data entry corresponding to the at least one data item, a data entry in the at least one data entry being represented in the string format and comprising a key and a value; and obtaining a second data portion, the second data portion being empty.

According to some implementations of the present disclosure, the obtaining module 720 is further configured to obtain, in response to receiving a first access request from a business logic of the application for the data item, a data object corresponding to the data item based on a data entry corresponding to the data item in the at least one data entry, the data object being represented in the object format; store the data object into the second data portion; and remove a data entry from the first data portion.

According to some implementations of the present disclosure, the obtaining module 720 is further configured to: obtain a name and a data value of the data item from the definition of the data item; and set the key of the data entry based on the name, and set the value of the data entry based on the data value.

According to some implementations of the present disclosure, the obtaining module 720 is further configured to determine a name of the data object based on the key of the data entry; and determine an instance of the data object based on the value of the data entry.

According to some implementations of the present disclosure, the object format is stored in a form of hash map and the instance has a type specified by the definition.

According to some implementations of the present disclosure, the data item is of a complex data type, a value of the complex data type comprises a nested sub-data item, and the obtaining module is further configured to determine the value of the data entry based on the sub-data item, the value comprising a sub-data entry associated with the sub-data item.

According to some implementations of the present disclosure, the obtaining module 720 is further configured to: obtain a sub-instance of the sub-data object based on the sub-data entry; and add the sub-instance to the instance.

According to some implementations of the present disclosure, the first format is an object format and the second format is a string format, and the obtaining module 720 is further configured to obtain, in response to receiving a second access request of a business logic of the application for the data item, a data entry corresponding to the data item based on a data object corresponding to the data item in the first data portion, the data entry being represented in the string format; write the data entry to the second portion; and remove the data object from the first portion.

According to some implementations of the present disclosure, the mixed data is stored in a heap of a memory of a device for executing the application.

FIG. 8 shows a block diagram of an apparatus 800 capable of implementing various implementations of the present disclosure. It should be understood that the computing device 800 shown in FIG. 8 is merely example and should not constitute any limitation on the functionality and scope of the implementations described herein. The computing device 800 shown in FIG. 8 may be used to implement the methods described above.

As shown in FIG. 8, the computing device 800 is in the form of a general-purpose computing device. Components of the electronic device 800 may include, but are not limited to, one or more processors or processing units 810, a memory 820, a storage device 830, one or more communications units 840, one or more input devices 850, and one or more output devices 860. The processing unit 810 may be an actual or virtual processor and may perform various processes according to programs stored in the memory 820. In a multiprocessor system, a plurality of processing units execute computer executable instructions in parallel, so as to improve the parallel processing capability of the computing device 800.

The computing device 800 typically includes a number of computer storage media. Such media may be any available media that are accessible by computing device 800, including, but not limited to, volatile and non-volatile media, removable and non-removable media. The memory 820 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium such as a flash drive, a magnetic disk, or any other medium that may be used to store information and/or data (for example, training data for training) and that may be accessed within the computing device 800.

The electronic device 800 may further include additional removable/non-removable, volatile/nonvolatile storage media. Although not shown in FIG. 8, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 implements communication with other electronic devices through a communication medium. In addition, functions of components of the electronic device 800 may be implemented by a single computing cluster or a plurality of computing machines, and these computing machines can communicate through a communication connection. Thus, the electronic device 800 may operate in a networked environment using logical connections to one or more other servers, network personal computers (PCs), or another network node.

The input device 850 may be one or more input devices such as a mouse, keyboard, trackball, etc. The output device 860 may be one or more output devices such as a display, speaker, printer, etc. The electronic device 800 may also communicate with one or more external devices (not shown) such as a storage device, a display device, or the like through the communication unit 840 as required, and communicate with one or more devices that enable a user to interact with the electronic device 800, or communicate with any device (e. g., a network card, a modem, or the like) that enables the electronic device 800 to communicate with one or more other electronic devices. Such communication may be performed via an input/output (I/O) interface (not shown).

According to an example implementation of the present disclosure, a computer readable storage medium is provided, on which a computer-executable instruction is stored, where the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatuses, devices, and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is example, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for managing data in an application, comprising:
receiving raw data in the application, the raw data comprising a definition of at least one data item; and
obtaining mixed data associated with the at least one data item, the mixed data comprising a first data portion in a first format and a second data portion in a second format,
wherein the first format comprises any one of a string format and an object format, the second format comprises the other one of the string format and the object format, and with regard to a data item in the at least one data item, the mixed data comprises the data item represented in the first format or the data item represented in the second format.

2. The method of claim 1, wherein the first format is the string format and the second format is the object format, and obtaining the mixed data comprises:
obtaining the first data portion based on the definition of the at least one data item, the first data portion comprising at least one data entry corresponding to the at least one data item, a data entry in the at least one data entry being represented in the string format and comprising a key and a value; and
obtaining the second data portion, the second data portion being empty.

3. The method of claim 2, further comprising:
in response to receiving a first access request from a business logic of the application for the data item, obtaining a data object corresponding to the data item based on a data entry corresponding to the data item in the at least one data entry, the data object being represented in the object format;
storing the data object into the second data portion; and
removing the data entry from the first data portion.

4. The method of claim 3, wherein obtaining the first data portion comprises:
obtaining a name and a data value of the data item from the definition of the data item; and
setting the key of the data entry based on the name, and setting the value of the data entry based on the data value.

5. The method of claim 4, wherein obtaining the data object comprises:
determining a name of the data object based on the key of the data entry; and
determining an instance of the data object based on the value of the data entry.

6. The method of claim 5, wherein the object format is stored in a form of hash map and the instance has a type specified by the definition.

7. The method of claim 5, wherein the data item is of a complex data type, a value of the complex data type comprises a nested sub-data item, wherein obtaining the data entry comprises determining the value of the data entry based on the sub-data item, the value comprising a sub-data entry associated with the sub-data item.

8. The method of claim 7, wherein obtaining the instance of the data object comprises:
obtaining a sub-instance of the sub-data object based on the sub-data entry; and
adding the sub-instance to the instance.

9. The method of claim 1, wherein the first format is an object format and the second format is a string format, and the method further comprising:
in response to receiving a second access request of a business logic of the application for the data item, obtaining a data entry corresponding to the data item based on a data object corresponding to the data item in the first data portion, the data entry being represented in the string format;
writing the data entry to the second portion; and
removing the data object from the first portion.

10. The method of claim 1, wherein the mixed data is stored in a heap of a memory of a device for executing the application.

11. An electronic device, comprising:
at least one processing unit; and
at least one memory coupled to the at least one processing unit and storing instructions for execution by the at least one processing unit that, when executed by the at least one processing unit, cause the electronic device to perform a method for managing data in an application, the method comprising:
receiving raw data in the application, the raw data comprising a definition of at least one data item; and
obtaining mixed data associated with the at least one data item, the mixed data comprising a first data portion in a first format and a second data portion in a second format,
wherein the first format comprises any one of a string format and an object format, the second format comprises the other one of the string format and the object format, and with regard to a data item in the at least one data item, the mixed data comprises the data item represented in the first format or the data item represented in the second format.

12. The device of claim 11, wherein the first format is the string format and the second format is the object format, and obtaining the mixed data comprises:
obtaining the first data portion based on the definition of the at least one data item, the first data portion comprising at least one data entry corresponding to the at least one data item, a data entry in the at least one data entry being represented in the string format and comprising a key and a value; and
obtaining the second data portion, the second data portion being empty.

13. The device of claim 12, wherein the method further comprises:
in response to receiving a first access request from a business logic of the application for the data item, obtaining a data object corresponding to the data item based on a data entry corresponding to the data item in the at least one data entry, the data object being represented in the object format;
storing the data object into the second data portion; and
removing the data entry from the first data portion.

14. The device of claim 13, wherein obtaining the first data portion comprises:
obtaining a name and a data value of the data item from the definition of the data item; and
setting the key of the data entry based on the name, and setting the value of the data entry based on the data value.

15. The device of claim 14, wherein obtaining the data object comprises:
determining a name of the data object based on the key of the data entry; and
determining an instance of the data object based on the value of the data entry.

16. The device of claim 15, wherein the object format is stored in a form of hash map and the instance has a type specified by the definition.

17. The device of claim 15, wherein the data item is of a complex data type, a value of the complex data type comprises a nested sub-data item, wherein obtaining the data entry comprises determining the value of the data entry based on the sub-data item, the value comprising a sub-data entry associated with the sub-data item.

18. The device of claim 17, wherein obtaining the instance of the data object comprises:
obtaining a sub-instance of the sub-data object based on the sub-data entry; and
adding the sub-instance to the instance.

19. The device of claim 11, wherein the first format is an object format and the second format is a string format, the mixed data is stored in a heap of a memory of a device for executing the application, and the method further comprises:
in response to receiving a second access request of a business logic of the application for the data item, obtaining a data entry corresponding to the data item based on a data object corresponding to the data item in the first data portion, the data entry being represented in the string format;
writing the data entry to the second portion; and
removing the data object from the first portion.

20. A non-transitory computer readable storage medium on which a computer program is stored, the computer program, when executed by a processor, causes the processor to implement a method for managing data in an application, the method comprising:
receiving raw data in the application, the raw data comprising a definition of at least one data item; and
obtaining mixed data associated with the at least one data item, the mixed data comprising a first data portion in a first format and a second data portion in a second format,
wherein the first format comprises any one of a string format and an object format, the second format comprises the other one of the string format and the object format, and with regard to a data item in the at least one data item, the mixed data comprises the data item represented in the first format or the data item represented in the second format.
